(19) United States
(12) Patent Application Publication
(10) Pub. No.: US 2020/0107913 A1
(43) Pub. Date: Apr. 9, 2020

(54) SYSTEM OF COMPONENTS FOR COMFORTABLY, EASILY, AND PRECISELY INSTALLING A COMPLETE DENTAL IMPLANT, INCLUDING THE CROWN, AND A METHOD OF INSTALLING THE COMPLETE DENTAL IMPLANT, INCLUDING THE CROWN

(71) Applicant: Jonathon Yigal Yahav, Skokie, IL (US)

(72) Inventor: Jonathon Yigal Yahav, Skokie, IL (US)

(21) Appl. No.: 16/155,837

(22) Filed: Oct. 9, 2018

(51) Int. Cl. A61C 8/00

(52) U.S. Cl. CPC A61C 8/0022; A61C 8/0093; A61C 8/0089; A61C 8/0075; A61C 8/005

(57) ABSTRACT

A system of components for comfortably, easily, and precisely installing a complete dental implant, including the crown, and a method of installing the complete dental implant, including the crown, is disclosed. The components comprise a dental implant, an impression transfer, a lab analog, and an abutment to which the crown is to be permanently installed.

### FIELD OF THE INVENTION

The present invention relates generally to dental implants, and more particularly to a system of components for comfortably, easily, and precisely installing a complete dental implant, including the crown, and a method of installing the complete dental implant, including the crown.

### BACKGROUND OF THE INVENTION

A dental implant may seem relatively simple and straightforward to most common or lay people that are not intimately familiar with the overall structure and function of a dental implant, but in reality, there are a relatively large number of structural components and procedural steps that must be utilized and undertaken in order to successfully implant a dental implant into a patient's mouth so as to permanently serve in lieu of a missing tooth. For example, there are innumerable patents and patent application publications disclosing all kinds of implants per se, however, the implant per se is only one component of the complete implant system which will serve as the replacement tooth to be permanently installed within a patient's mouth. Other components of the complete implant system comprise, for example, a preselected or predetermined abutment which is effectively affixed to the implant, and the crown or replacement tooth which is effectively affixed to the abutment. All of these components need to be precisely selected or manufactured such that the replacement tooth to be permanently installed within the patient's mouth will effectively be properly aligned and sized relative to the patient's neighboring teeth between which the new implant tooth will be disposed, as well as appear to be identical in color to the patient's neighboring teeth between which the new implant tooth will be disposed. In this manner, one would not be readily capable of distinguishing the implanted tooth from the patient's original teeth.

A need therefore exists in the art for a new and improved dental implant. Another need exists in the art for a new and improved system of components for comfortably, easily, and precisely installing a complete dental implant, including the crown, and a method of installing the complete dental implant, including the crown. A further need exists in the art for a new and improved system of components for comfortably, easily, and precisely installing a complete dental implant, including the crown, and a method of installing the complete dental implant, including the crown, wherein the system comprises the use of a dental implant, a covering screw, an impression transfer, a lab analog, an abutment, and a crown, whereby as a result of the use of such a system of components for comfortably, easily, and precisely installing a complete dental implant, including the crown, and a method of installing the complete dental implant, including the crown, the dental implant will be precisely manufactured, easily and comfortably installed within the patient's mouth, and will be properly positioned, sized, aligned, and colored so as to match the original teeth of the patient. A still further need exists in the art for a new and improved system of components for comfortably, easily, and precisely installing a complete dental implant, including the crown, and a method of installing the complete dental implant, including the crown, wherein the system comprises the use of a dental implant, a covering screw, an impression transfer, a lab analog, an abutment, and a crown, whereby as a result of the use of such a system of components for comfortably, easily, and precisely installing a complete dental implant, including the crown, and a method of installing the complete dental implant, including the crown, the dental implant will be precisely manufactured, easily and comfortably installed within the patient's mouth, and will be properly positioned, sized, aligned, and colored so as to match the original teeth of the patient whereby, in turn, the implanted tooth will not able to be effectively distinguished from the patient's original teeth.

### OVERALL OBJECTIVES OF THE INVENTION

Therefore, an overall objective of the present invention is to provide a new and improved dental implant. Another overall objective of the present invention is to provide a new and improved system of components for comfortably, easily, and precisely installing a complete dental implant, including the crown, and a method of installing the complete dental implant, including the crown. A further overall objective of the present invention is to provide a new and improved system of components for comfortably, easily, and precisely installing a complete dental implant, including the crown, and a method of installing the complete dental implant, including the crown, wherein the system comprises the use of a dental implant, a covering screw, an impression transfer, a lab analog, an abutment, and a crown, whereby as a result of the use of such a system of components for comfortably, easily, and precisely installing a complete dental implant, including the crown, and a method of installing the complete dental implant, including the crown, the dental implant will be precisely manufactured, easily and comfortably installed within the patient's mouth, and will be properly positioned, sized, aligned, and colored so as to match the original teeth of the patient. A still further overall objective of the present invention is to provide a new and improved system of components for comfortably, easily, and precisely installing a complete dental implant, including the crown, and a method of installing the complete dental implant, including the crown, wherein the system comprises the use of a dental implant, a covering screw, an impression transfer, a lab analog, an abutment, and a crown, whereby as a result of the use of such a system of components for comfortably, easily, and precisely installing a complete dental implant, including the crown, and a method of installing the complete dental implant, including the crown, the dental implant will be precisely fabricated, easily and comfortably installed within the patient's mouth, and will be properly positioned, sized, aligned, and colored so as to match the original teeth of the patient whereby, in turn, the implanted tooth will not able to be effectively distinguished from the patient's original teeth.

### SUMMARY OF THE INVENTION

In accordance with the principles and teachings of the present invention, there is disclosed a new and improved system of components for comfortably, easily, and precisely installing a complete dental implant, including the crown, and a method of installing the complete dental implant, including the crown. More particularly, the system of components, and the method of installing the implant, comprises a dental implant which has been implanted within a particular implant site within the patient's mouth, and a covering screw which is threadedly inserted into the dental implant so as to effectively cover the implant and prevent foreign matter from entering the implant site over the course of several weeks, during which time the implant will become affixed within the patient's jawbone as a result of osseointegration developed between the implant and the patient's jawbone. Alternatively, in lieu of the covering screw, a healing abutment may be inserted into the implant, or still further, a temporary abutment and a temporary crown may be attached to the implant. Subsequently, the covering screw or healing or temporary abutment is removed from the implant and an impression transfer is inserted into the implant. The proximal end of the impression transfer is provided with an axial bore that can have any one of a multitude of configurations such that a tool, having a corresponding head configuration formed thereon, can be inserted into the axial bore of the impression transfer so as to force the impression transfer into the implant. The impression transfer comprises a distal end which is adapted to be inserted into the implant and which is also adapted to be tightly secured therein as a result of the tip portion of the distal end being split while a substantially surrounding ball or cylinder portion engages the internal threaded portion of the implant so as to cause the split end tip portions of the impression transfer to move toward each other whereby the distal end of the impression transfer will effectively be secured within the implant by means of a friction fit. Subsequently, an impression is taken, wherein it is noted that the proximal end of the impression transfer is provided with a plurality of axially spaced, radially outwardly extending wing members which will become fixedly embedded within the impression material once the impression material hardens.

Once the impression material has hardened sufficiently, the impression material is removed from the patient's mouth, and since the wing members of the impression transfer are effectively buried or embedded within the impression material, the impression transfer will likewise caused to be removed from the implant along with the impression material. In addition, since the wing members of the impression transfer are effectively buried or embedded within the impression material, the split distal end tip portion of the impression transfer is now exposed. Accordingly, a lab analog is now disposed atop the exposed split distal end tip portion of the impression transfer whereby the impression transfer and the lab analog effectively comprise an upside-down combination of the impression transfer when disposed within the implant. The purpose of the lab analog, as seated atop the impression transfer, is to simply, in effect,, mimic the implant and its positional orientation relative to the impression material. As was similar to the friction fit installation of the split distal end tip portion of the impression transfer into the implant, the lab analog is inserted over the split distal end tip portion of the impression transfer such that the split distal end tip portion of the impression transfer is effectively inserted into the lab analog by means of a friction fit. The next step in the process is to select an appropriate abutment relative to the lab analog. The lab analog may be internally threaded such that a threaded screw may be inserted through the abutment and threadedly engaged with the internal thread of the lab analog. Lastly, the crown of the new tooth implant is fabricated so as to match the patient's other teeth in size and color such that the crown of the new tooth will effectively match the patient's other teeth precisely so as not to be capable of being distinguished from the patient's original teeth. The abutment is then threadedly disengaged from the lab analog and a mounting screw is inserted through the abutment so as to threadedly engage the implant whereupon a newly fabricated crown can then be cemented onto the abutment which has been fixedly secured to the implant.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a cross-sectional view of an implant with a covering screw threadedly disposed therein;

FIG. 2 is a side elevational view of the impression transfer component;

FIG. 3 is a perspective view of the new and improved impression transfer component, as illustrated within FIG. 2, showing, however, the impression transfer component from the perspective of the proximal end portion thereof;

FIG. 4 is a perspective view of the new and improved impression transfer component, as illustrated within FIGS. 2 and 3, showing, however, the impression transfer component from the perspective of the distal end portion thereof;

FIG. 5 is a vertical cross-sectional view of the impression transfer component, as illustrated within FIGS. 2-4, inserted into the dental implant, as illustrated within FIG. 1, after the covering screw has been removed from the dental implant, in preparation for the taking of an impression of the patient's teeth within the jaw within which the dental implant is to be permanently implanted;

FIG. 6 is a side elevational view of a lab analog as it would effectively be positionally disposed relative to the distal end portion of the impression transfer component material in preparation for the selection of an appropriate abutment member which will, in turn, enable the creation or development of a proper crown for the implanted tooth;

FIG. 7 is a front elevational view of an appropriately sized abutment member mated with the lab analog disclosed within FIG. 6 such that a proper crown member be fabricated for permanent attachment to the abutment member; and

FIG. 8 is a vertical cross-sectional view of an implant, similar to the implants disclosed within FIGS. 1 and 5, having an abutment member fixedly secured therein by means of a vertically oriented axially extending screw such that a finalized crown component, not shown, can be fixedly secured to the abutment member and thereby complete the dental implant.

### DETAILED DESCRIPTION OF THE PREFERRED EMBODIMENT

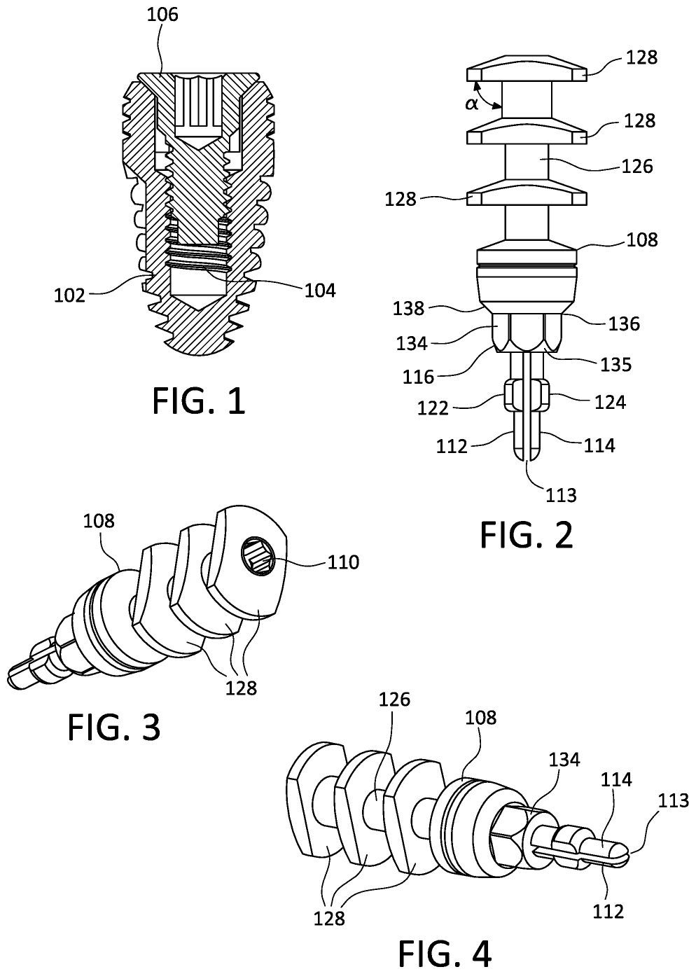

Referring now to the drawings, and more particularly to FIGS. 1 and 7 thereof, a new and improved system of components for comfortably, easily, and precisely installing a complete dental implant, including the crown, and a method of installing the complete dental implant, including the crown, is disclosed and is generally indicated by the reference character 100. More particularly, the system of components, and the method of installing the implant, comprises a dental implant 102 which has been implanted within a particular implant site within the patient's mouth, and it is seen that the dental implant 102 is provided with an axially oriented internally threaded portion 104 for initially accommodating a covering screw 106 which is threadedly inserted into the dental implant 102 so as to effectively cover the implant 102 and thereby prevent foreign matter from entering the implant site over the course of several weeks, during which time the implant 102 will become affixed within the patient's jawbone as a result of osseointegration developed between the implant 102 and the patient's jawbone. Alternatively, in lieu of the covering screw 106, a healing abutment, not shown, may be inserted into the implant 102, or still further, a temporary abutment, also not shown, and a temporary crown, also not shown, may be attached to the implant 102.

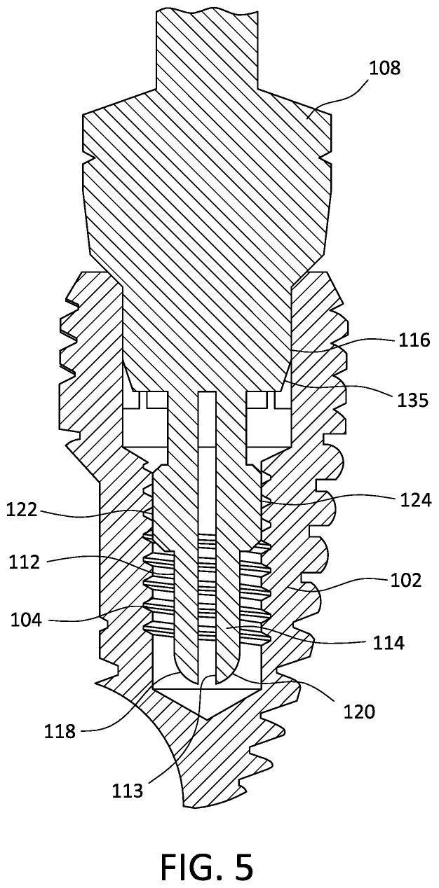

Subsequently, the covering screw 106 or healing or temporary abutment is removed from the implant 102 and an impression transfer component 108, as illustrated within FIGS. 2-6, is inserted into the implant 102. As can best be seen from FIG. 3, the proximal end of the impression transfer component 108 is provided with an axial bore or socket 110 that can have any one of a multitude of geometrical configurations such that a tool, not shown, having a corresponding head configuration formed thereon, can be inserted into the axial bore or socket 110 of the impression transfer component 108 so as to effectively force the impression transfer component 108 into the implant 102 whereby the impression transfer component 108 will be properly seated within the implant 102 as is clearly illustrated within FIG. 5. More particularly, it is seen that the distal end portion of the impression transfer component 108 comprises a pair of radially spaced prongs 112,114 which are fixedly attached to and extend axially away from a lower body portion 116 of the impression transfer component 108 such that the pair of radially spaced prongs 112,114 are effectively flexible with respect to each other in view of the fact that each one of the prongs 112,114 is effectively mounted in a cantilevered manner upon the lower body portion 116 of the impression transfer component 108 and are spaced from each other by means of a space or slot 113. In addition, it is seen that the distal tip portions 118,120 are rounded or arcuate in cross-section such that the distal end portion of the impression transfer component 108 can be easily guided into the axially extending threaded bore 104 of the implant 102. In addition, a substantially semi-circular ball or protuberance 122,124 extends around each one of a pair of axially central portions of the radially spaced prongs 112,114 of the transfer impression component 108 and are adapted to snugly engage inner wall portions of the axially extending threaded bore 104 of the implant 102. It is to be appreciated that this procedure is readily achieved due to the fact that, since the diametrical extent of the pair of semi-circular balls or protuberances 122,124 is substantially greater than the diametrical extent of the pair of radially spaced prongs 112,114, then as the distal end portion of the impression transfer component 108 is inserted into the axially extending internally threaded bore 104 of the implant 102, the pair of radially spaced prongs 112,114 will be forced or compressed together so as to permit the pair of semi-circular balls or protuberances 122,124 to be inserted into and accommodated within the axially extending internally threaded bore 104 of the implant 102. Furthermore, due to the inherent flexibility of the pair of radially spaced prongs 112,114, as a result of their cantilevered mounting upon the lower body portion 116 of the impression transfer component 108, the pair of radially spaced prongs 112,114 will tend or try to regain their original non-compressed state, thereby forcing the pair of semi-circular balls or protuberances 122,124 radially outwardly so as to snugly engage inner wall portions of the axially extending internally threaded bore 104 of the implant 102 by means of a friction fit.

With reference again being made to FIGS. 2-4, it is seen that the proximal end of the impression transfer component 108 comprises an axially oriented stem portion 126 to which there is fixedly secured a plurality of axially spaced, radially extending discs, plates, or wing members 128. As indicated in FIG. 2, the underside surface portion of each one of the plurality of axially spaced, radially extending discs, plates, or wing members 128 preferably define an angle α that is 90° with respect to the axially oriented stem portion 126, however the angle α may vary between 80° and 100°. It is to be appreciated that since the distal end portion of the impression transfer component 108 is disposed within the implant 102, then the proximal end portion of the impression transfer component 108, comprising the axially oriented stem portion 126 and the plurality of discs, plates, or wing members 128, projects axially outwardly from the implant 102. Accordingly, it is now time for an impression to be taken of the patient's teeth. As is conventional, impression material is inserted into an impression mold, the impression mold is inserted between the patient's upper and lower jaws, and the patient closes his or her jaws whereby an impression of the patient's teeth is made within the impression material. The plurality of discs, plates, or wing members 128 will therefore be embedded within the impression material, and once the impression material has hardened sufficiently, the impression material is removed from the patient's mouth, and since the plurality of discs, plates, or wing members 128 of the impression transfer component 108 are effectively buried or embedded within the impression material, the impression transfer component 108 will likewise be removed from the implant 102 along with the impression material. In addition, it is to be appreciated that since the plurality of discs, plates, or wing members 128 of the impression transfer component 108 are effectively buried or embedded within the impression material, the split distal end portion of the impression transfer component 108, comprising the pair of radially spaced prongs 112,114, is now exposed.

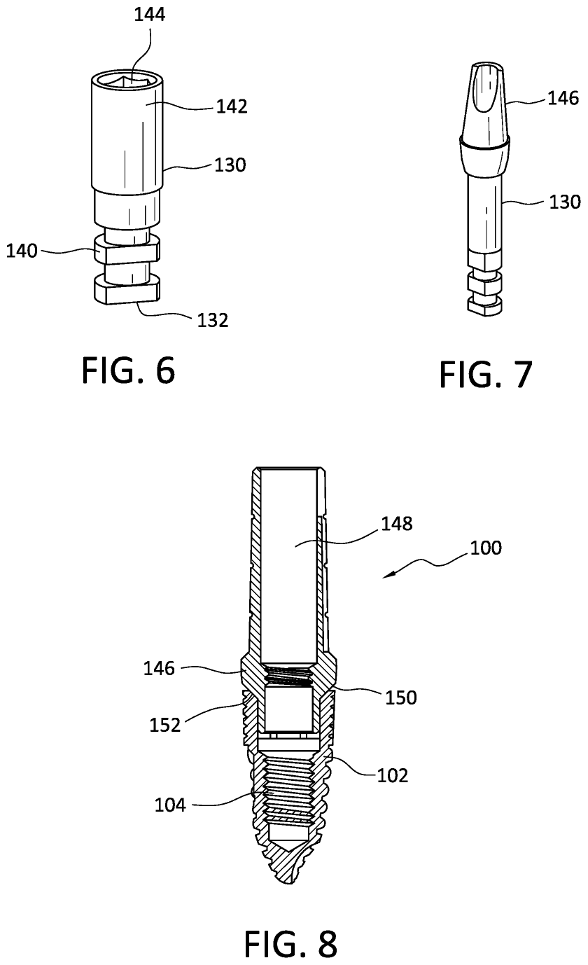

At this point in time, and with reference being made to FIG. 6, a lab analog 130 is now disposed atop the exposed split distal end tip portion of the impression transfer component 108 whereby the impression transfer component 108 and the lab analog 130 will effectively comprise an upside-down combination of the impression transfer component 108 and the implant 102 when the impression transfer component 108 was disposed within the implant 102. The purpose of the lab analog 130, as seated atop the impression transfer component 108, is to simply, in effect, mimic or effectively take the place of the implant 102 and its positional orientation relative to the impression material which, in turn, effectively mimics or provides positional orientation with respect to the patient's teeth. As was similar to the friction fit installation of the split distal end tip portion 112,114 of the impression transfer component 108 into the implant 102, the lab analog 130 is inserted over the split distal end tip portion 112,114 of the impression transfer component 108 such that the split distal end tip portion 112,114 of the impression transfer component 108 is effectively inserted into the lab analog 130 by means of a friction fit until the lowermost open end portion 132 of the lab analog 130 is disposed atop the split distal end tip portion 112,114 of the impression transfer component 108 and effectively encases the multi-faceted enlarged portion 134 of the impression transfer component 108 as can best be seen in FIG. 2.

It is to be noted that with respect to the lower body portion 116, and in particular, with respect to the plurality of faceted side portions 134, a plurality of upstanding or upwardly rounded triangular sections 135 are interposed between each pair of adjacent faceted side portions 134. The purposes of these upwardly rounded triangular section 135 is to smoothly guide the lowermost open end portion 132 of the lab analog 130 over the faceted side portions 134. At this time, the lowermost open end portion 132 of the lab analog 130 will encounter an annular edge portion 136 of an annular frusto-conically configured portion 138, as can also best be seen in FIG. 2, whereby it is known that the lab analog 130 is now properly seated upon the impression transfer component 108. In order to facilitate this mounting of the lab analog 130 atop the the split distal end tip portion 112,114 of the impression transfer component 108, the lower end portion 140 of the lab analog 130 is provided with an internal bore, not shown, for accommodating the split distal end tip portion 112,114 of the impression transfer component 108, while the upper end portion 142 of the lab analog 130 is provided with a bore or socket 144, similar to the bore or socket 110 defined within the proximal end portion of the impression transfer component 108, as shown in FIG. 3, for a tool which will enable the lab analog 130 to be mounted atop the the split distal end tip portion 112,114 of the impression transfer component 108. As was also the case with the implant 102, the internal bore, not shown, of the lab analog 130 is threaded such that the pair of semi-circular balls or protuberances 122,124 can engage the threaded bore, not shown, of the lab analog 130.

The next step in the process is to select an appropriate abutment component 146, as seen in FIG. 7, relative to the lab analog 130. As has been noted, the lab analog 130 is internally threaded such that a threaded screw may be inserted through the abutment 146 and threadedly engaged with the internal thread of the lab analog 130. The abutment 146 effectively serves as a gauge or guide in connection with which a suitable permanent crown, not shown, can be fabricated so as to match the patient's other teeth in size and color such that the crown of the newly implanted tooth will effectively match the patient's other teeth precisely so as not to be capable of being distinguished from the patient's original teeth. The abutment component 146 is then threadedly disengaged from the lab analog 130 and a mounting screw 148 is inserted through the abutment component 146 so as to threadedly engage the internally threaded bore 104 of the implant 102, as seen in FIG. 8, whereupon a newly fabricated crown can then be cemented onto the abutment component which has been fixedly secured to the implant 102. As can also be seen from FIG. 8, the abutment component 146 is provided with an axial intermediate annular frusto-conically configured rim portion 150 which is adapted to be seated upon an upper or outer frusto-conically configured end or rim portion 152 of the implant 102. In this manner, when such mating or seating of the lower annular frusto-conically configured portion 150 of the abutment component 146 upon the upper frusto-conically configured portion 152 of the implant 102 is achieved as a result of the threaded engagement of the mounting screw 148 within the threaded bore 104 of the implant, it is assured that the abutment component 146 has in fact been properly secured within the implant 102.

Obviously, many variations and modifications of the present invention are possible in light of the above teachings. It is therefore to be understood that within the scope of the appended claims, the present invention may be practiced otherwise than as specifically described herein.

### REFERENCE NUMBER KEY

100—Implant system
102—Implant
104—Internal thread of implant 102
106—Covering screw for implant 102
108—Impression transfer
110—Bore for tool in proximal end of impression transfer
112/114—Prongs on distal end of impression transfer
113—Space or slot between prongs 11²/₁14
116—Lower body portion of impression transfer
118/120—Rounded tips of prongs 112/114
122/124—Protuberances on mid-section of prongs 112/114
126—Axial stem of impression transfer 108
128—Wings, plates, or discs of impression transfer 108
130—Lab analog
132—Lowermost open end portion of lab analog 130
134—Multi-faceted portion of impression transfer 108
135—Upstanding rounded triangular portions between adjacent facets 134
136—Annular edge portion of impression transfer 108
138—Frusto-conical portion of impression transfer 108
140—Lower end portion of lab analog 130
142—Upper end portion of lab analog 130
144—Bore within proximal end of lab analog 130
146—Abutment
148—Threaded fastener for securing abutment 146 to implant 102
150—Annular frusto-conical portion of abutment 146
152—Annular frusto-conical portion of implant 102
α—Angles between undersurface portions of wings 128 and axial stem 126

What is claimed as new and desired to be protected by Letters Patent, is:

1. A system of components for installing a dental implant within a patient's mouth, comprising:
a dental implant having an internally threaded bore;
an impression transfer having a distal end adapted to be inserted into said internally threaded bore of said dental implant, and a proximal end adapted to project outwardly from said dental implant so as to have impression material fixedly secured thereon;
a lab analog having a first end into which said distal end of said impression transfer after the impression material and said impression transfer have been removed from said implant; and
an abutment adapted to be fixedly secured to a second opposite end of said lab analog so as to serve as a guide or gauge to which a dental crown is to be permanently mounted so as to match other teeth of the patient.

2. The system as set forth in claim 1, further comprising:
a covering screw threadedly engaged within said internally threaded bore of said implant so as to cover said implant for a predetermined period of time, after said implant has been implanted within an implantation site, during which osseointegration occurs between said implant and jawbone material of the patient's jawbone into which said implant has been implanted.

3. The system as set forth in claim 1, wherein:
said distal end portion of said impression transfer comprises a pair of radially spaced prongs which are mounted upon an end portion of said impression transfer in a cantilevered manner; and
a pair of protuberances respectively mounted upon each one of said pair of radially spaced prongs for engaging said internally threaded bore of said implant when said distal end portion of said impression transfer is inserted into said implant such that said impression transfer is effectively retained within said implant by a friction fit defined between said pair of protuberances respectively mounted upon said pair of radially spaced prongs and internal wall portions of said internally threaded bore of said implant.

4. The system as set forth in claim 3, wherein:
said proximal end of said impression transfer comprises a geometrically-configured bore within which a tool can be inserted in order to facilitate the friction fit of said distal end portion of said impression transfer within said implant.

5. The system as set forth in claim 1, wherein:
said proximal end of said impression transfer comprises an axially extending stem portion upon which a plurality of axially spaced, radially extending wing members, plates, or discs are mounted so as to fixedly secure said impression transfer within the impression material once the impression material hardens sufficiently.

6. The system as set forth in claim 5, wherein:
undersurface portions of each one of said plurality of wing members, plates, or discs define an angle α which is between 80°-100° with respect to said axially extending stem portion.

7. The system as set forth in claim 6, wherein:
said angle α is 90°.

8. The system as set forth in claim 1, wherein:
said lab analog comprises an internally threaded bore and a second end for receiving a threaded fastener for securing said abutment to said lab analog.

9. The system as set forth in claim 1, wherein:
an intermediate portion axial portion of said abutment has a first frusto-conical configuration; and
an outer end portion of said implant has a second frusto-conical configuration such that when said abutment is fixedly secured to said implant, said second frusto-conical end portion of said implant will accommodate said first frusto-conical portion of said abutment whereby said abutment is stably mounted upon said implant.

10. The system as set forth in claim 1, further comprising:
a threaded fastener for passage through said abutment and for engagement with said internally threaded bore of said implant so as to fixedly secure said abutment to said implant.

11. A method for installing a dental implant within a patient's mouth, comprising the steps of:
implanting a dental implant, having an internally threaded bore, in an implantation site defined within a patient's mouth;
inserting an impression transfer, having a distal end portion, into said internally threaded bore of said dental implant, and a proximal end which is adapted to project outwardly from said dental implant;
taking a dental impression whereby the impression material will be fixedly secured upon said proximal end of said impression transfer;
respectively removing the impression material and said impression transfer from the patient's mouth and said implant;
mounting a first end of a lab analog onto said distal end of said impression transfer; and
mounting an abutment upon a second opposite end, of said lab analog so as to serve as a guide or gauge to which a dental crown is to be permanently mounted so as to match other teeth of the patient.

12. The method as set forth in claim 11, further comprising the step of:
threadedly engaging a covering screw within said internally threaded bore of said implant so as to cover said implant for a predetermined period of time, after said implant has been implanted within the implantation site, during which osseointegration occurs between said implant and jawbone material of the patient's jawbone into which said implant has been implanted.

13. The method as set forth in claim 11, wherein:
said distal end portion of said impression transfer comprises a pair of radially spaced prongs which are mounted upon an end portion of said impression transfer in a cantilevered manner; and
a pair of protuberances respectively mounted upon each one of said pair of radially spaced prongs for engaging said internally threaded bore of said implant when said distal end portion of said impression transfer is inserted into said implant such that said impression transfer is effectively retained within said implant by a friction fit defined between said pair of protuberances respectively mounted upon said pair of radially spaced prongs and internal wall portions of said internally threaded bore of said implant.

14. The method as set forth in claim 11, wherein:
said proximal end of said impression transfer comprises a geometrically-configured bore within which a tool can be inserted in order to facilitate the friction fit of said distal end portion of said impression transfer within said implant.

15. The method as set forth in claim 11, wherein:
said proximal end of said impression transfer comprises an axially extending stem portion upon which a plurality of axially spaced, radially extending wing members, plates, or discs are mounted so as to fixedly secure said impression transfer within the impression material once the impression material hardens sufficiently.

16. The method as set forth in claim 15, wherein:
undersurface portions of each one of said plurality of wing members, plates, or discs define an angle α which is between 80°-100° with respect to said axially extending stem portion.

17. The method as set forth in claim 16, wherein:
said angle α is 90°.

18. The method as set forth in claim 11, wherein:
said lab analog comprises an internally threaded bore and a second end for receiving a threaded fastener for securing said abutment to said lab analog.

19. The method as set forth in claim 11, wherein:
an intermediate portion axial portion of said abutment has a first frusto-conical configuration; and
an outer end portion of said implant has a second frusto-conical configuration such that when said abutment is fixedly secured to said implant, said second frusto-conical end portion of said implant will accommodate said first frusto-conical portion of said abutment whereby said abutment is stably mounted upon said implant.

20. The method as set forth in claim 11, further comprising the step of:
inserting a threaded fastener through said abutment for engagement with said internally threaded bore of said implant so as to fixedly secure said abutment to said implant.
